(19) United States
(12) Patent Application Publication
(10) Pub. No.: US 2012/0292477 A1
(43) Pub. Date: Nov. 22, 2012

(54) Apparatus For Moving A Display Apparatus

(75) Inventor: Ralph HUBER, Mendig (DE)

(73) Assignee: Stabilus GmbH, Koblenz (DE)

(21) Appl. No.: 13/473,097

(22) Filed: May 16, 2012

(30) Foreign Application Priority Data
May 17, 2011 (DE) 20 2011 102 481.8

(51) Int. Cl. F16M 13/00

(52) U.S. Cl. 248/550

(57) ABSTRACT

Apparatus for moving a display appliance, for example a television set, or a display apparatus of the display appliance between a display position and a standby position, with a remote control for operating the display appliance, with a drive unit for moving the display appliance or the display apparatus thereof between the display position and the standby position, and with a control unit for actuating the drive unit. The control unit includes a detection device for detecting the operational state of the display appliance. The control unit actuates the drive unit depending on output signals from the detection device such that the drive unit moves the display appliance or the display apparatus thereof into the display position when said display appliance is switched on and moves the display appliance or the display apparatus thereof into the standby position when said display appliance is switched off.

### BACKGROUND OF THE INVENTION

1. Field of the Invention

The present invention relates to an apparatus for moving a display appliance, for example a television set, or a display apparatus of the display appliance between a display position and a standby position.

2. Background of the Invention

Modern television sets have a very small overall depth—for example if a TFT display is used—and this allows the television set to be accommodated in for example part of a piece of furniture when not in use.

Apparatuses of the relevant type are known, which have a remote control for the display appliance and a drive unit for moving the display appliance between a display position and a standby position. By way of example, the drive unit is embodied as a lifting column in the known apparatuses. The known apparatuses furthermore have a control unit for actuating the drive unit. In order to increase the user comfort, the drive unit in the known apparatuses has a remote control, by means of which the movement of the display appliance between the display position thereof and the standby position thereof is triggered. In order to use the display appliance, the drive unit is first of all actuated by means of the remote control such that it moves the display appliance from the standby position into the display position, i.e. for example extends the display appliance out of a piece of furniture in which it is accommodated in the standby position. The display appliance can subsequently be switched on by means of the remote control thereof. When the display appliance is no longer required, it is first of all switched off by means of the remote control thereof. The drive unit can subsequently be actuated by means of the remote control thereof such that the display appliance is retracted from the display position into the standby position.

### SUMMARY OF THE INVENTION

The underlying concept of the present invention resides in using the same remote control on the one hand to move the display appliance from the standby position into the display position and back again, i.e. for example extend the display appliance out of a piece of furniture and retract it therein, and on the other hand to operate the display appliance, for example a television set. This dispenses with the need for a second remote control, and so the user experiences increased comfort. According to the present invention, provision is made for the control unit to have a detection device that detects the operational state of the display appliance. By way of example, according to the present invention the detection device thus detects whether the display appliance is in the completely switched-off state, in the standby mode or in the completely switched-on state. Depending on output signals from the detection device, the control unit actuates the drive unit such that the drive unit moves the display appliance or the display apparatus thereof into the display position when said display appliance is switched on and moves the display appliance or the display apparatus thereof into the standby position when said display appliance is switched off.

For example, the detection device can detect that the display appliance is switched from the standby mode into the completely switched-on state, and so the control unit accordingly triggers a movement of the display appliance from the standby position into the display position. For example, if the detection device detects that the display appliance is switched from the completely switched-on state into the standby mode, the control unit can as a result of this trigger a movement of the display appliance from the display position back into the standby position and accordingly actuate the drive unit.

According to the present invention, switching on is understood to mean that the display appliance is moved from a completely switched-off state or a standby mode into a completely switched-on state. In a corresponding manner switching off according to the invention is understood to mean a switching procedure in which the display appliance is switched from a completely switched-on state into a standby mode or a completely switched-off state.

According to the present invention, a movement of the display appliance between the rest position thereof and the display position thereof can be triggered when the user actuates a switch provided on the display appliance. For example, if the display appliance is in the completely switched-off state and switched on by means of a switch provided on the display appliance, the detection device can detect this switching procedure and accordingly trigger a movement of the display appliance into the display position. In place of such a trigger or in addition thereto, the control unit can also actuate the drive unit depending on an actuation of the remote control.

According to the present invention, it is also possible to combine triggering dependent on an actuation of the remote control and triggering dependent on an actuation of a switch provided on the display appliance such that, for example, a movement of the display appliance into the display position is triggered when the display appliance is switched on by means of a switch arranged thereon or actuated by means of the remote control.

The detection device can be embodied in any suitable manner. By way of example, if the remote control is an infrared remote control, the detection device can, for example, have a separate infrared receiver. If this separate infrared receiver determines that the user actuates the display appliance by means of the remote control, the detection device can transmit an appropriate signal to the control unit, which thereupon actuates the drive unit in order to move the display appliance into the display position. According to the invention, other detection mechanisms are also possible, which react to switching procedures that are triggered either by the remote control or by a switch provided on the display appliance. An extraordinarily advantageous embodiment of the invention provides for the detection device to have at least one current sensor which is connected to the voltage supply of the display appliance for detection purposes such that the current sensor detects an increase in the power consumption of the display appliance when the display appliance is switched on by means of the remote control and detects a decrease in the power consumption of the display appliance when the display appliance is switched off by means of the remote control. This embodiment has a particularly simple design because suitable current sensors are available as relatively simple and cost-effective standard components and can easily be integrated into a control unit of the display appliance. A further advantage of this embodiment consists of the fact that the current sensor reacts to an increase or decrease in the power consumption of the display appliance, independently of how this increase or decrease is triggered. Thus, for example, it is possible that the display appliance is moved into the display position when either the remote control or a switch provided on the display appliance is actuated. Equally, the display appliance can then be moved into the standby position when it is switched off by either a switch provided on the display appliance or the remote control. If the display appliance should be prevented from already moving into the display position when it is switched from the completely switched-off state into the standby mode, the corresponding procedure can be triggered only when the power consumption of the display appliance exceeds a predetermined threshold. Correspondingly, the movement of the display appliance back into the standby position can already be triggered when the power consumption drops below this threshold.

By way of example and in particular, the display appliance can be a television set or a monitor. However, another advantageous embodiment of the invention provides for the display appliance to be a video projector, the display apparatus of which is formed by a projection surface that can be moved between an operational position and a standby position. Here, the projection surface can be a substantially rigid projection surface. However, it is also possible for the projection surface to be embodied in a fabric-type fashion. In the case of such an embodiment, the drive unit can for example be embodied as a winding device for rolling and unrolling the fabric-type projection surface.

The movement of the display appliance between the display position and the standby position can follow any suitable motion. In this respect, an advantageous embodiment of the invention provides for the drive unit to be embodied as a lifting unit for raising or lowering the display appliance or the display apparatus thereof

The various features of novelty which characterize the invention are pointed out with particularity in the claims annexed to and forming a part of the disclosure. For a better understanding of the invention, its operating advantages, and specific objects attained by its use, reference should be had to the drawing and descriptive matter in which there are illustrated and described preferred embodiments of the invention.

### BRIEF DESCRIPTION OF THE DRAWINGS

In the following, the invention will be explained in more detail on the basis of the attached, highly schematic drawing in which an exemplary embodiment of an apparatus according to the present invention is illustrated. All features that are described, illustrated in the drawing and claimed in the patent claims form the subject matter of the present invention, both individually and in any combination among themselves, irrespective of their grouping in the patent claims and their dependency references and irrespective of their description or illustration in the drawing.

FIG. 1 is a schematic block diagram of an apparatus according to the present invention;

FIG. 2 is a perspective view of a display appliance that can be moved by means of the apparatus as per FIG. 1, in the standby position thereof;

FIG. 3 is a side view of the display appliance as per FIG. 2;

FIG. 4 is a perspective view of the display appliance as per FIG. 2 in the display position thereof;

FIG. 5 is a side view of the display appliance as per FIG. 4; and

FIG. 6 is a side view of a video projector and projection surface.

### DETAILED DESCRIPTION OF THE PRESENTLY PREFERRED EMBODIMENTS

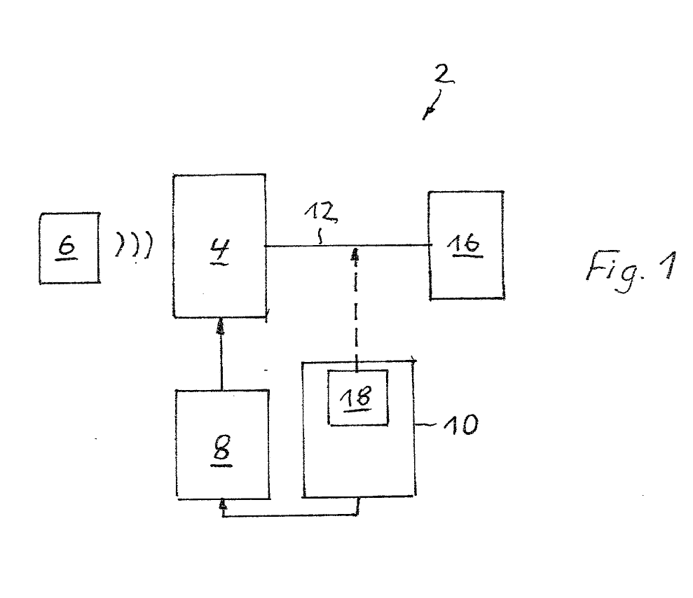

FIG. 1 illustrates a first exemplary embodiment of an apparatus 2 according to the invention for moving a display appliance 4, for example a television set, between a display position and a standby position. The apparatus 2 includes a remote control 6, by means of which the display appliance 4, which is also named appliance below, can be actuated in a conventional and widely known manner. The apparatus 2 furthermore has a drive unit 8 for moving the appliance 4 between the display position and the standby position. The apparatus 2 furthermore has a control unit 10 for actuating the drive unit 8.

The appliance 4 is connected to a voltage supply apparatus 16, for example a power grid, via a voltage supply line 12.

According to the present invention, the control unit 10 has detection device for detecting the operational state of the appliance 4, with the detection device in the illustrated exemplary embodiment detecting whether the appliance 4 is in the standby mode or in the completely switched-on state. According to the invention, the control unit 10 actuates the drive unit 8 dependent on output signals from the detection device such that the drive unit 8 moves the appliance 4 into the display position when said appliance is switched on and moves the appliance 4 into the standby position when said appliance is switched off.

In the illustrated exemplary embodiment, the detection device has a current sensor 18 which is connected to the voltage supply of the appliance 4 for detection purposes such that the current sensor detects an increase in the power consumption of the appliance 4 when the appliance 4 is switched on by means of the remote control 6 and detects a decrease in the power consumption when the appliance 4 is switched off by means of the remote control 6. To this end, the current sensor 18 senses the current flowing in the voltage supply line 12.

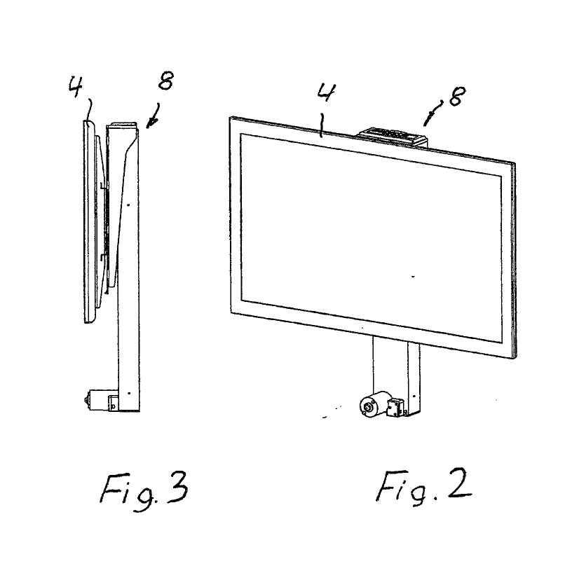

FIG. 2 shows a perspective illustration of the appliance 4 in the standby position thereof. In the illustrated exemplary embodiment, the drive unit is embodied as a lifting unit for raising or lowering the appliance 4 and has a telescopic lifting column operated by electric motors. A person skilled in the art is generally aware of the design and functionality of a corresponding telescopic lifting column, and therefore these will not be explained in any more detail here.

FIG. 3 shows the appliance 4 as per FIG. 2 in a lateral view.

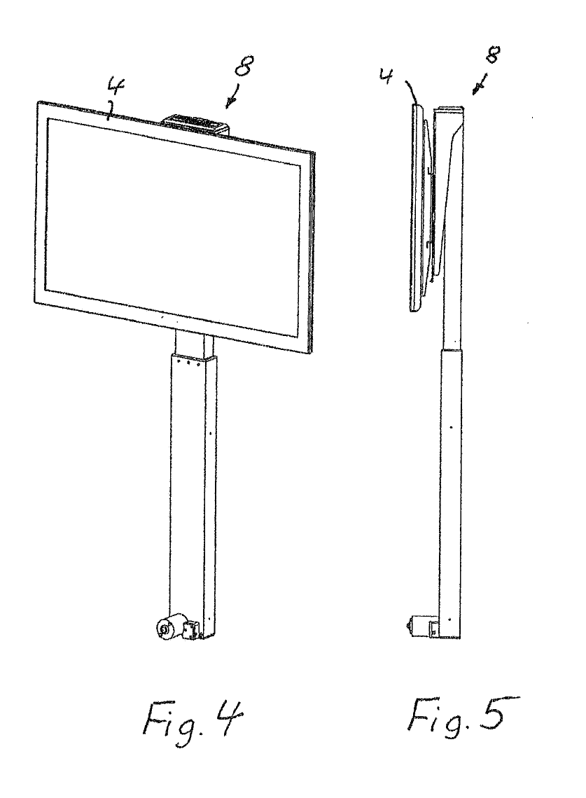

FIG. 4 shows the appliance 4 in the display position thereof, into which it was raised by means of the drive unit 8. By way of example, in the standby position the appliance 4 can be accommodated retracted into a piece of furniture while it is extended out of the piece of furniture in the display position.

FIG. 5 shows the appliance 4 as per FIG. 4 in a lateral view.

The functionality of the apparatus 2 according to the invention is as follows:

If the remote control 6 is used to switch the appliance 4 from the standby mode thereof into the completely switched-on state, this leads to an increase in the power consumption of the appliance 4. This increase is sensed by the current sensor 18 in the supply line 12. Depending on the associated output signals of the current sensor 18, the control unit 10 actuates the drive unit 8 such that the latter moves the appliance 4 from the standby position illustrated in FIG. 2 into the display position illustrated in FIG. 4.

If the user uses the remote control 6 to switch the appliance 4 from the completely switched-on state into the standby mode, the power consumption of the appliance 4 decreases. This is detected by the current sensor 18. Accordingly, the control unit 10 actuates the drive unit 8 such that the latter moves the appliance 4 from the display position illustrated in FIG. 4 back into the standby position illustrated in FIG. 2. Here a threshold decision can be made in the control unit 10 such that the respective movement is only triggered when the power consumption of the appliance 4 reaches a predetermined value (when being switched on) or drops therebelow (when being switched off). This prevents a movement of the appliance 4 already being triggered when the latter is switched from a completely switched-off state into the standby mode by means of a switch provided on the appliance 4.

However, it is also possible to trigger the movement of the appliance 4 between the display position and the standby position also or only if a switch arranged on the appliance 4, for example an on/off switch, is actuated.

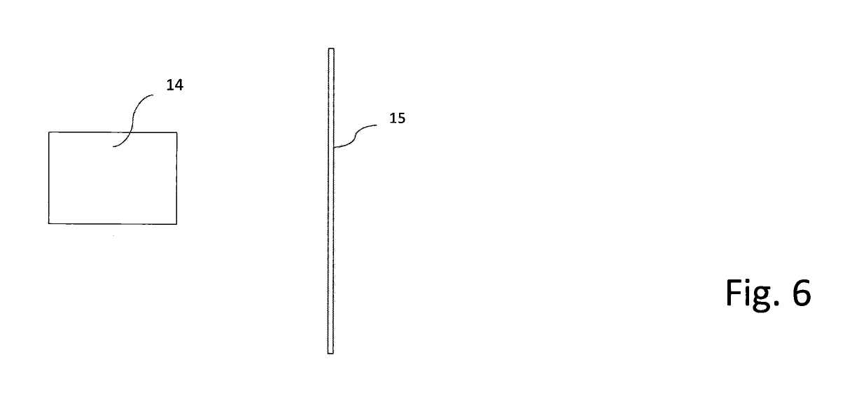

As shown in FIG. 6, another advantageous embodiment of the invention provides for the display appliance to be a video projector 14, the display apparatus of which is formed by a projection surface 15 that can be moved between an operational position and a standby position. Here, the projection surface 15 can be a substantially rigid projection surface.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

I claim:

1. An apparatus for moving a display appliance or a display apparatus of the display appliance between a display position and a standby position, said apparatus comprising:
a remote control for operating said display appliance;
a drive unit for moving one of said display appliance and said display apparatus between the display position and the standby position;
a control unit for actuating said drive unit;
said control unit (10) comprising a detection device for detecting an operational state of said display appliance (4);
said control unit (10) constructed to actuate said drive unit (8) depending on output signals from said detection device such that said drive unit (8) moves one of said display appliance (4) and said display apparatus into the display position when said display appliance is switched on and moves one of said display appliance (4) and said display apparatus into the standby position when said display appliance is switched off.

2. The apparatus according to claim 1, wherein said control unit (10) actuates the drive unit (8) depending on an actuation of the remote control.

3. The apparatus according to claim 1, wherein said detection device comprises at least one current sensor (18) connected to a voltage supply (16) of said display appliance (4) such that said current sensor (18) detects an increase in power consumption of said display appliance (4) when said display appliance (4) is switched on by said remote control (6) and detects a decrease in power consumption of said display appliance (4) when said display appliance (4) is switched off by said remote control (6).

4. The apparatus according to claim 1, wherein said display appliance is a video projector (14); and said the display apparatus is formed by a projection surface (15) moveable between a display position and a standby position.

5. The apparatus according to claim 1, wherein said drive unit (8) is a lifting unit for raising or lowering one of said display appliance (4) and said display apparatus.

6. The apparatus according to claim 2, wherein said display appliance is a video projector (14); and said the display apparatus is formed by a projection surface (15) moveable between a display position and a standby position.

7. The apparatus according to claim 2, wherein said drive unit (8) is a lifting unit for raising or lowering one of said display appliance (4) and said display apparatus.

8. The apparatus according to claim 3, wherein said drive unit (8) is a lifting unit for raising or lowering one of said display appliance (4) and said display apparatus.
